(19) United States
(12) Patent Application Publication
(10) Pub. No.: US 2020/0079945 A1
(43) Pub. Date: Mar. 12, 2020

(54) CURABLE COMPOSITION AND TIRE SEALANT COMPOSITION

(71) Applicant: BRIDGESTONE CORPORATION, Chuo-ku Tokyo (JP)

(72) Inventor: Junko MATSUSHITA, Tachikawa-shi, Tokyo (JP)

(73) Assignee: BRIDGESTONE CORPORATION, Chuo-ku Tokyo (JP)

(21) Appl. No.: 16/336,662

(22) PCT Filed: Sep. 8, 2017
(86) PCT No.: PCT/JP2017/032549

§ 371 Date: Mar. 26, 2019

(30) Foreign Application Priority Data
Sep. 27, 2016 (JP) 2016-188693

(51) Int. Cl. C08L 23/22; C08L 51/00; C08L 51/04; C08L 51/08; C08L 45/00; C08L 93/04

(52) U.S. Cl. CPC C08L 23/22; C08L 51/003; C08L 51/04; C08L 51/08; B29C 73/02; C08L 93/04; C08L 2205/03; C08L 2312/00; C08L 45/00

(57) ABSTRACT

Provided are a curable composition and a tire sealant composition which are capable of maintaining a balance among processability, shape retention, and elongation at a high level. The curable composition comprises the following components A to C: A: a reactive silicon group-containing polymer; B: one or more polymers having a number average molecular weight of 50,000 or less, the polymers being selected from the group consisting of polybutene, polyisobutylene, polyisobutylene butadiene, polypentene, and polyisopentene; and C: one or more resins selected from the group consisting of C5 resin, C9 resin, C5-C9 resin, dicyclopentadiene resin, rosin resin, alkylphenol resin, and terpene phenol resin.

### TECHNICAL FIELD

The present disclosure relates to curable compositions and tire sealant compositions.

### BACKGROUND

Some known puncture-resistant pneumatic tires comprise a layer of sealant material disposed along the inner surface of the tire. In a tire provided with a layer of sealant material, when a nail or other foreign object penetrates through the tread, the sealant material functions to automatically seal the puncture hole (see, e.g., PTL 1).

However, conventional sealant materials are difficult to process due to high tackiness and flowability. This complicates the operation of providing the sealant material on the inner surface of the tire and may cause inclusion of air bubbles. Further, it becomes difficult to keep quality such as puncture repair ability (i.e., shape retention and elongation) stable.

### CITATION LIST

### Patent Literature

[PTL 1] JP2009269446A

### SUMMARY

### Technical Problem

An object of the present disclosure is therefore to provide a curable composition and a tire sealant composition which are capable of maintaining a balance among processability, shape retention, and elongation at a high level.

As used herein, “shape retention” means the ability to maintain shape over time.

### Solution to Problem

Specifically, curable compositions of the present disclosure comprise the following components A to C:

A: a reactive silicon group-containing polymer;

B: one or more polymers having a number average molecular weight of 50,000 or less, which are selected from the group consisting of polybutene, polyisobutylene, polyisobutylene butadiene, polypentene, and polyisopentene; and

C: one or more resins selected from the group consisting of C5 resin, C9 resin, C5-C9 resin, dicyclopentadiene resin, rosin resin, alkylphenol resin, and terpene phenol resin.

### Advantageous Effect

According to the present disclosure, it is possible to provide a curable composition and a tire sealant composition which are capable of maintaining a balance among processability, shape retention, and elongation at a high level.

### BRIEF DESCRIPTION OF THE DRAWINGS

In the accompanying drawings:

FIG. 1 is a partial cross-sectional view illustrating an example of a pneumatic tire in which a tire sealant composition according to an embodiment of the present disclosure is used.

### DETAILED DESCRIPTION

(Curable Composition, Tire Sealant Composition)

Hereinafter, a curable composition of the present disclosure will be described in detail based on one embodiment thereof.

The curable composition of the present disclosure comprises component A, component B, component C, and an optional component.

A tire sealant composition of the present disclosure comprises a curable composition of the present disclosure. A tire in which the tire sealant composition of the present disclosure is used has a cured product of the curable composition as a sealant.

<Component A>

The component A is a polymer having a reactive silicon group.

Processability can be improved by blending the reactive silicon group-containing polymer into the curable composition.

«Reactive Silicon Group-Containing Polymer»

The term “reactive silicon group” as used herein means “a group which has a silicon atom to which a hydrolyzable group or a hydroxyl group is bound and which can be crosslinked by a silanol condensation reaction.”

Any desired hydrolyzable group can be selected as appropriate and examples thereof include halogen, alkoxy, acyloxy, aminooxy, and mercapto groups. These hydrolyzable groups may be used singly or in combination of two or more.

Preferred is alkoxy group for mild hydrolysis and easy handling.

In addition to the reactive silicon group, the reactive silicon group-containing polymer may have other functional groups such as amino and/or mercapto group, which may react with an epoxy group.

Any desired reactive silicon group-containing polymer can be selected as appropriate and examples thereof include liquid polymers which comprise polyoxyalkylene ether, polyester, (meth)acrylic polymer, polyisobutylene or the like as a backbone and which comprise a silyl or silanol group having a hydrolyzable group (e.g., halogen, alkoxy, or mercapto) at terminals or side chains. These polymers may be used singly or in combination of two or more.

Preferred is an alkoxysilyl-modified polymer from the viewpoint of improving processability.

The reactive silicon group-containing polymer can be produced by the method described in JPS61268720A.

Any desired commercially available reactive silicon group-containing polymer can be used and examples thereof include alkoxysilyl-modified polyisobutylene derived from Penguin Seal IB7000 available from Sunstar Engineering Inc., and those available under the tradenames Silyl 5B25, SAT200, and SAT030 from Kaneka Corporation.

The reactive silicon group-containing polymer can have any desired number average molecular weight, preferably a number average molecular weight of 2,000 to 10,000. When the number average molecular is 2,000 or more, sufficient elongation can be obtained while allowing desired physical properties to be developed. When the number average molecular is 10,000 or less, dissociation of the reactive silicon group of the component A can be prevented.

<Component B>

The component B is one or more polymers having a number average molecular weight of 50,000 or less, which are selected from the group consisting of polybutene, polyisobutylene, polyisobutylene butadiene, polypentene, and polyisopentene.

The component B functions as a plasticizer. With the component B being included, tackiness and elongation can be improved.

The polymer as the component B can have any desired number average molecular weight so long as it is 50,000 or less, preferably has a number average molecular weight of 400 to 40,000. When the number average molecular weight is 50,000 or less, mixer kneading is possible at 100° C. or below. When the number average molecular weight is 400 or more, it is possible to prevent the components from transferring to the tire inner liner. When the number average molecular weight is 40,000 or less, sufficient dispersion can be obtained even with kneading at 100° C. or below.

The component B can be included in any desired amount, preferably in an amount of 150 parts by mass or less, more preferably 50 parts by mass to 120 parts by mass, per 100 parts by mass of the component A.

When the component B is included in an amount of 150 parts by mass or less per 100 parts by mass of the component A, shape retention and elongation can be improved.

<Component C>

The component C is one or more resins selected from the group consisting of C5 resin, C9 resin, C5-C9 resin, dicyclopentadiene resin, rosin resin, alkylphenol resin, and terpene phenol resin.

The component C functions as a tackifier. With the component C being included, tackiness and elongation can be improved.

The component C can be included in any desired amount, preferably in an amount of 20 parts by mass or less, more preferably 10 parts by mass to 20 parts by mass, per 100 parts by mass of the component A.

When the component C is included in an amount of 20 parts by mass or less per 100 parts by mass of the component A, shape retention and elongation can be improved.

«C5 Resin»

C5 resin refers to a C5 synthetic petroleum resin, which is a solid polymer obtained by polymerizing a C5 fraction using a Friedel Crafts catalyst such as AlCl₃ or BF₃.

Any desired C5 resin can be selected as appropriate and examples thereof include (i) copolymers which comprise isoprene, cyclopentadiene, 1,3-pentadiene, 1-pentene or the like as a main component; (ii) copolymers of 2-pentene and dicyclopentadiene; and (iii) polymers which comprise 1,3-pentadiene as a main component. These C5 resins may be used singly or in combination of two or more.

«C9 Resin»

C9 resin refers to a C9 synthetic petroleum resin, which is a solid polymer obtained by polymerizing a C9 fraction using a Friedel Crafts catalyst such as AlCl₃ or BF₃.

Any desired C9 resin can be selected as appropriate and examples thereof include copolymers which comprise indene, methylindene, α-methylstyrene, vinyltoluene or the like as a main component. These C9 resins may be used singly or in combination of two or more.

«C5-C9 Resin»

C5-C9 resin refers to a C5-C9 synthetic petroleum resin, which is a solid polymer obtained by polymerizing a C5-C11 fraction using a Friedel Crafts catalyst such as AlCl₃ or BF₃.

Any desired C5-C9 resin can be selected as appropriate and examples thereof include copolymers which comprise styrene, vinyltoluene, a-methylstyrene, indene or the like as a main component. These C5-C9 resins may be used singly or in combination of two or more.

«Dicyclopentadiene Resin»

Any desired dicyclopentadiene resin can be selected as appropriate and examples thereof include dicyclopentadiene and indene, These dicyclopentadiene resins may be used singly or in combination of two or more.

«Rosin Resin»

Any desired rosin resin can be selected as appropriate and examples thereof include natural resin rosins such as gum rosin, tall oil rosin, and wood rosin; polymerized rosin, and partially hydrogenated rosin thereof; glycerin ester rosin, and partially hydrogenated rosin and completely hydrogenated rosin thereof; and pentaerythritol ester rosin, and partially hydrogenated rosin and polymerized rosin thereof. These rosin resins may be used singly or in combination of two or more.

«Alkylphenol Resin»

Any desired alkylphenol resin can be selected as appropriate and examples thereof include alkylphenol-acetylene resin such as p-tert-butylphenol-acetylene resin; and alkylphenol-formaldehyde resin having a low degree of polymerization. These alkylphenol resins may be used singly or in combination of two or more.

«Terpene Phenol Resin»

The terpene phenol resin can be obtained by reacting terpenes with various phenols using a Friedel Crafts catalyst or by further condensing with formalin.

Any desired terpene can be selected as appropriate and preferred examples thereof include monoterpene hydrocarbons such as a-pinene and limonene. Preferred are those containing a-pinene, with a-pinene being particularly preferred.

<Optional Component>

Any desired optional component can be selected as appropriate and examples thereof include curing agents, plasticizers, antioxidants, UV absorbers, light stabilizers, and surface modifiers.

«Curing Agent»

Curing by post-crosslinking can be accelerated by mixing the curing agent with a base material containing the components A to C described above.

When the base material is mixed with the curing agent, curing gradually occurs by post-crosslinking due to moisture in the air, so that processability can be improved as compared with conventional vulcanized sealants.

Any desired curing agent can be used as appropriate and examples thereof include tin carboxylates, amine compounds, and calcium carbonate. These curing agents may be used alone or in combination of two or more.

The curing agent can be included in any desired amount as appropriate, preferably in an amount of 0.5 parts by mass to 10 parts by mass per 100 parts by mass of the component A.

«Plasticizer»

Any desired plasticizer can be selected as appropriate and examples thereof include diisodecyl phthalate (DIDP) and diisononyl phthalate (DINP). These plasticizers may be used alone or in combination of two or more.

The plasticizer can be included in any desired amount as appropriate, preferably in an amount of 30 parts by mass to 300 parts by mass per 100 parts by mass of the component A.

«Antioxidant»

Any desired antioxidant can be selected as appropriate and examples thereof include amines and hindered amines. These antioxidants may be used alone or in combination of two or more.

«UV Absorber»

Any desired UV absorber can be selected as appropriate and examples thereof include hindered amines and aromatic amines. These UV absorbers may be used alone or in combination of two or more.

«Light Stabilizer»

Any desired light stabilizer can be selected as appropriate and examples thereof include hindered amines and phosphate compounds. These light stabilizers may be used alone or in combination of two or more.

«Surface Modifier»

Any desired surface modifier can be used and examples thereof include calcium carbonate and stearic acid. These surface modifiers may be used alone or in combination of two or more.

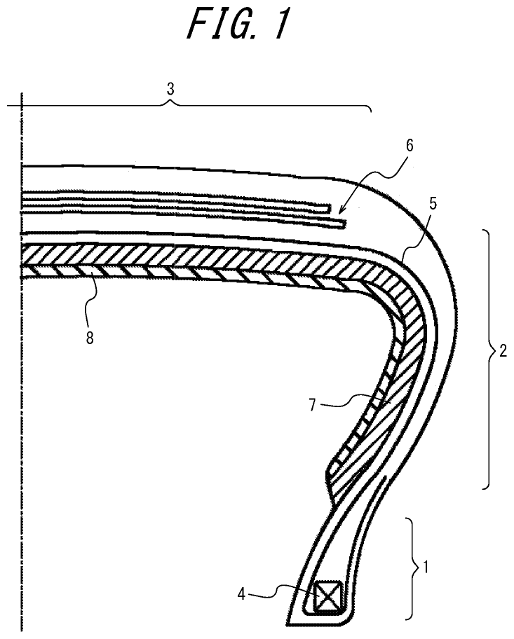

FIG. 1 is a partial cross-sectional view illustrating an example of a pneumatic tire in which a tire sealant composition according to an embodiment of the present disclosure is used. In this example of a pneumatic tire, the tire comprises a pair of beads 1, a pair of sidewalls 2 extending radially outside the the respective beads 1, and a tread 3 bridging between the sidewalls 2. A carcass 5 composed of a carcass ply extending in a toroidal shape is disposed between bead cores 4 of the beads 1 and a belt 6 having two belt layers is disposed radially outside the tread 3 of the carcass 5, thereby forming a skeleton of the tire. In this example of a pneumatic tire, from the carcass 5 side, a sealant 7 and an inner liner 8 are sequentially disposed on the inner surface side of the carcass 5.

The sealant 7 can be of any desired thickness and is preferably 1.5 mm to 4.0 mm in thickness.

Thus, the curable composition of the present disclosure comprises the following components A to C:

A: a reactive silicon group-containing polymer;

B: one or more polymers having a number average molecular weight of 50,000 or less, which are selected from the group consisting of polybutene, polyisobutylene, polyisobutylene butadiene, polypentene, and polyisopentene; and

C: one or more resins selected from the group consisting of C5 resin, C9 resin, C5-C9 resin, dicyclopentadiene resin, rosin resin, alkylphenol resin, and terpene phenol resin.

With the curable composition of the present disclosure, a balance among processability, shape retention, and elongation can be maintained at a high level.

In the curable composition of the present disclosure, the component A is preferably an alkoxysilyl-modified polymer. With this configuration, processability can be improved.

In the curable composition of the present disclosure, the component A preferably has a number average molecular weight of 2,500 to 10,000. With this configuration, dissociation of the reactive silicon group of the component A can be prevented.

In the curable composition of the present disclosure, the component B is preferably included in an amount of 60 parts by mass or less per 100 parts by mass of the component A. With this configuration, shape retention and elongation can be improved.

In the curable composition of the present disclosure, the component C is preferably included in an amount of 20 parts by mass or less per 100 parts by mass of the component A. With this configuration, shape retention and elongation can be improved.

A tire sealant composition of the present disclosure comprises a curable composition of the present disclosure.

According to the sealant composition of the present disclosure, it is possible to maintain a balance among processability, shape retention, and elongation at a high level.

### EXAMPLES

The present disclosure will be described in detail based on Examples, which however shall not be construed as limiting the scope of the present disclosure. Appropriate modifications and alterations can be made without departing from the spirit of the present disclosure.

Compositions of Examples 1-2, 4-11 and Comparative Examples 1-5 were prepared based on the recipes shown in Table 1. A composition of Example 3 is prepared based on the recipe shown in Table 1.

For the compositions of Examples 1-2, 4-11 and Comparative Examples 1-5, the following evaluations were made. For the composition of Example 3, the following evaluations are made. The numbers in “recipe” in Table 1 indicate parts by mass.

<Processability>

For the compositions of Examples 1-2, 4-11 and Comparative Examples 1-5, flow characteristics were measured with a capillograph at 60° C. and 50 mm/min using a die having a diameter of 1 mm to evaluate processability based on the following viscosity criteria. For the composition of Example 3, flow characteristics are measured with a capillograph at 60° C. and 50 mm/min using a die having a diameter of 1 mm to evaluate processability based on the following viscosity criteria. The results are shown in Table 1.

### «Evaluation Criteria»

A: Less than 80 Pa·s

B: 80 Pa·s or more and less than 150 Pa·s

C: 150 Pa·s or more

<Shape Retention>

For each of the compositions of Examples 1-2, 4-11 and Comparative Examples 1-5, a sample cut into a 3 cm×3 cm square was placed in a 70° C. oven and allowed to stand for 3 days to evaluate shape retention based on the following criteria. For the composition of Example 3, a sample cut into a 3 cm×3 cm square is placed in a 70° C. oven and allowed to stand for 3 days to evaluate shape retention based on the following criteria. The results are shown in Table 1.

### «Evaluation Criteria»

S: Deformation amount of each side of the sample is less than 1%

A: Deformation amount of each side of the sample is 1% or more and less than 3%

B: Deformation amount of each side of the sample is 3% or less and less than 10%

C: Deformation amount of each side of the sample is 10% or less

Please amend paragraph [0044] by replacing it with the following:

<Elongation>

For each of the compositions of Examples 1-2, 4-11 and Comparative Examples 1-5, using a sample cut into 40 mm×4 mm×5 mm size, tensile test was performed at 25° C. at a rate of 8.3 mm/sec to evaluate elongation based on following evaluation criteria. For the composition of Example 3, using a sample cut into 40 mm×4 mm×5 mm size, tensile test is performed at 25° C. at a rate of 8.3 mm/sec to evaluate elongation based on following evaluation criteria. The results are shown in Table 1.

### «Evaluation Criteria»

S: 2,000% or more

A: 1,200% or more and less than 2000%

B: 700% or more and less than 1200%

C: less than 700%

<Puncture Repair Ability (on Actual Vehicle)>

A nail having a diameter of 4.6 mm was pushed into a pneumatic tire having a sealant (thickness: 3 mm) produced using the tire sealant composition of each of Examples 1-2, 4-11 and Comparative Examples 1-5, and the appearance of the sealant was observed to evaluate the puncture repair ability (on actual vehicle) based on the following evaluation criteria. A nail having a diameter of 4.6 mm is pushed into a pneumatic tire having a sealant (thickness: 3 mm) produced using the tire sealant composition of Example 3, and the appearance of the sealant is observed to evaluate the puncture repair ability (on actual vehicle) based on the following evaluation criteria. The evaluation results are shown in Table 1.

### «Evaluation Criteria»

S: Sealant covers almost the entire nail

A: Sealant covers part of the nail

C: Sealant does not follow the nail, or the sealant tears off at the base of the nail.

TABLE 1

| | | | | | Comp. | | | | | Comp. | | Comp. | Comp. | | | | | | Comp. |
|---|---|---|---|---|---|---|---|---|---|---|---|---|---|---|---|---|---|---|---|
| | | | | Ex. 1 | Ex. 1 | Ex. 2 | Ex. 3 | Ex. 4 | Ex. 5 | Ex. 2 | Ex. 6 | Ex. 3 | Ex. 4 | Ex. 7 | Ex. 8 | Ex. 9 | Ex. 10 | Ex. 11 | Ex. 5 |
| Recipe | Base material | Component A | Alkoxysilyl-modified | 100 | — | — | — | — | 100 | 100 | 100 | 100 | 100 | 100 | 100 | 100 | 100 | 100 | 100 |
| | | | polyisobutylene (reactive | | | | | | | | | | | | | | | | |
| | | | silicon-containing | | | | | | | | | | | | | | | | |
| | | | polyisobutylene) | | | | | | | | | | | | | | | | |
| | | | (Mn = 2500)*1 | | | | | | | | | | | | | | | | |
| | | | Polyisobutylene not containing | — | 100 | — | — | — | — | — | — | — | — | — | — | — | — | — | — |
| | | | reactive silicon | | | | | | | | | | | | | | | | |
| | | | (Mn = 2500)*2 | | | | | | | | | | | | | | | | |
| | | | Alkoxysilyl-modified | — | — | 100 | — | — | — | — | — | — | — | — | — | — | — | — | — |
| | | | polyisobutylene (reactive | | | | | | | | | | | | | | | | |
| | | | Silicon-containing | | | | | | | | | | | | | | | | |
| | | | polyisobutylene) | | | | | | | | | | | | | | | | |
| | | | (Mn = 2000)*3 | | | | | | | | | | | | | | | | |
| | | | Alkoxysilyl-modified | — | — | — | 100 | — | — | — | — | — | — | — | — | — | — | — | — |
| | | | polyisobutylene (reactive | | | | | | | | | | | | | | | | |
| | | | silicon-containing | | | | | | | | | | | | | | | | |
| | | | polyisobutylene) | | | | | | | | | | | | | | | | |
| | | | (Mn = 10000)*4 | | | | | | | | | | | | | | | | |
| | | | Alkoxysilyl-modified | — | — | — | — | 100 | — | — | — | — | — | — | — | — | — | — | — |
| | | | polyisobutylene (reactive | | | | | | | | | | | | | | | | |
| | | | silicon-containing | | | | | | | | | | | | | | | | |
| | | | polyisobutylene) | | | | | | | | | | | | | | | | |
| | | | (Mn = 20000)*5 | | | | | | | | | | | | | | | | |
| | | Component B | Polyisobutylene | 10 | 10 | 10 | 10 | 10 | — | — | — | — | 20 | 20 | 60 | 55 | 60 | 70 | — |
| | | | (Mn = 30000)*6 | | | | | | | | | | | | | | | | |
| | | | Polyisobutylene | — | — | — | — | — | 10 | — | — | — | — | — | — | — | — | — | — |
| | | | (Mn = 50000)*7 | | | | | | | | | | | | | | | | |
| | | | Polyisobutylene | — | — | — | — | — | — | 10 | — | — | — | — | — | — | — | — | — |
| | | | (Mn = 60000)*8 | | | | | | | | | | | | | | | | |
| | | | Polybutene | — | — | — | — | — | — | — | 10 | — | — | — | — | — | — | — | — |
| | | | (Mn = 2900)*9 | | | | | | | | | | | | | | | | |
| | | | Maleic acid-modified | — | — | — | — | — | — | — | — | — | — | — | — | — | — | — | 20 |
| | | | polyisoprene | | | | | | | | | | | | | | | | |
| | | | (Mn = 34000) | | | | | | | | | | | | | | | | |
| | | Component C | C5 resin*10 | 10 | 10 | 10 | 10 | 10 | 10 | 10 | 10 | — | — | 20 | 15 | 20 | 25 | 20 | — |

| | | | | | | | | | | | | | | | | | |
|---|---|---|---|---|---|---|---|---|---|---|---|---|---|---|---|---|---|
| Evaluation | Processability | A | C | A | A | B | A | A | A | A | A | A | A | A | A | A | A |
| Results | Shape retention | A | A | A | A | A | B | C | A | C | C | A | A | A | A | B | B |
| | Elongation | S | S | B | A | A | B | C | S | C | C | A | S | A | B | B | C |
| | Puncture repair ability (on actual vehicle) | S | S | A | S | A | A | C | S | C | C | A | S | A | A | A | C |

*1Penguin Seal IB7000, manufactured by Sunstar Engineering Inc., number average molecular weight (Mn): 2,500
*2Bridgestone Corporation, number average molecular weight (Mn): 2,500
*3Bridgestone Corporation, number average molecular weight (Mn): 2,000
*4Bridgestone Corporation, number average molecular weight (Mn): 10,000
*5Bridgestone Corporation, number average molecular weight (Mn): 20,000
*6Tetrax 3T, manufactured by JXTG Nippon Oil & Energy Corporation, number average molecular weight (Mn): 30,000
*7Tetrax 5T, manufactured by JXTG Nippon Oil & Energy Corporation, number average molecular weight (Mn): 50,000
*8Tetrax 6T, manufactured by JXTG Nippon Oil & Energy Corporation, number average molecular weight (Mn): 60,000
*9HV 1900, manufactured by JXTG Nippon Oil & Energy Corporation, number average molecular weight (Mn): 2,900
*10Quinton A100, manufactured by Zeon Corporation

### REFERENCE SIGNS LIST

1 Bead
2 Sidewall
3 Tread
4 Bead core
5 Carcass
6 Belt
7 Sealant
8 Inner liner

1. A curable composition comprising the following components A to C:
A: a reactive silicon group-containing polymer;
B: one or more polymers having a number average molecular weight of 50,000 or less, the polymers being selected from the group consisting of polybutene, polyisobutylene, polyisobutylene butadiene, polypentene, and polyisopentene; and
C: one or more resins selected from the group consisting of C5 resin, C9 resin, C5-C9 resin, dicyclopentadiene resin, rosin resin, alkylphenol resin, and terpene phenol resin.

2. The curable composition of claim 1, wherein the component A is an alkoxysilyl-modified polymer.

3. The curable composition of claim 1, wherein the component A has a number average molecular weight of 2,500 to 10,000.

4. The curable composition of claim 1, wherein the component B is included in an amount of 60 parts by mass or less per 100 parts by mass of the component A.

5. The curable composition of claim 1, wherein the component C is included in an amount of 20 parts by mass or less per 100 parts by mass of the component A.

6. A tire sealant composition comprising the curable composition of claim 1.

7. The curable composition of claim 2, wherein the component A has a number average molecular weight of 2,500 to 10,000.

8. The curable composition of claim 2, wherein the component B is included in an amount of 60 parts by mass or less per 100 parts by mass of the component A.

9. The curable composition of claim 2, wherein the component C is included in an amount of 20 parts by mass or less per 100 parts by mass of the component A.

10. A tire sealant composition comprising the curable composition of claim 2.

11. The curable composition of claim 3, wherein the component B is included in an amount of 60 parts by mass or less per 100 parts by mass of the component A.

12. The curable composition of claim 3, wherein the component C is included in an amount of 20 parts by mass or less per 100 parts by mass of the component A.

13. A tire sealant composition comprising the curable composition of claim 3.

14. The curable composition of claim 4, wherein the component C is included in an amount of 20 parts by mass or less per 100 parts by mass of the component A.

15. A tire sealant composition comprising the curable composition of claim 4.

16. A tire sealant composition comprising the curable composition of claim 5.

17. The curable composition of claim 7, wherein the component B is included in an amount of 60 parts by mass or less per 100 parts by mass of the component A.

18. The curable composition of claim 7, wherein the component C is included in an amount of 20 parts by mass or less per 100 parts by mass of the component A.

19. A tire sealant composition comprising the curable composition of claim 7.

20. The curable composition of claim 8, wherein the component C is included in an amount of 20 parts by mass or less per 100 parts by mass of the component A.
